(19) United States
(12) Patent Application Publication
(10) Pub. No.: US 2025/0272116 A1
(43) Pub. Date: Aug. 28, 2025

(54) Systems and Methods for Dynamically Manipulating Data

(71) Applicant: Capital One Services, LLC, McLean, VA (US)

(72) Inventors: Kathryn Marie SIDLER, Plano, TX (US); Michael GARRIGAN, New York, NY (US)

(21) Appl. No.: 18/586,724

(22) Filed: Feb. 26, 2024

(51) Int. Cl. G06F 9/451; G06F 3/04847

(52) U.S. Cl. CPC G06F 9/451; G06F 3/04847

(57) ABSTRACT

Disclosed embodiments may include a method for dynamically manipulating data. The method may include receiving, via a first graphical user interface, a first indication from the user device indicating a first selection of first input data and receiving or retrieving, using the input template, the first input data. Then the method may include receiving, via a second graphical user interface, a second indication from the user device indicating one or more selected assumption templates and receiving, via a third graphical user interface, a third indication from the user device indicating a selected output configuration. The method may then include calculating the data analysis using the one or more selected assumption templates and the first input data from the input template and outputting the data analysis according to the third indication from the user device using the selected output configuration.

The disclosed technology relates to systems and methods for dynamically manipulating data. Specifically, this disclosed technology relates to a method for manipulating data using programming languages, templates, and graphical user interfaces.

### BACKGROUND

Forecasting tools have become more integrated with programming languages, which has created a shift away from traditional Microsoft tools such as Excel. As large data sources are analyzed using programming languages, an increase of manual manipulation of data is becoming necessary which can frustrate users, make it difficult to understand data trends, and ultimately cause an increased use of resources.

Accordingly, there is a need for improved systems and methods for dynamically manipulating data. Embodiments of the present disclosure are directed to this and other considerations.

### SUMMARY

Disclosed embodiments may include a system for dynamically manipulating data. The system may include one or more processors, and memory in communication with the one or more processors and storing instructions that, when executed by the one or more processors, are configured to cause the system to provide dynamically manipulating data. The system may generate a first graphical user interface displaying an input template and transmit the first graphical user interface to a user device for display. The system then may receive, via the first graphical user interface, a first indication from the user device indicating a first selection of first input data and receive or retrieve, using the input template, the first input data. Then, generate a second graphical user interface displaying an option of the one or more assumption templates, each of the one or more assumption templates configured to perform a data analysis and transmit the second graphical user interface to the user device for display. The system may then receive, via the second graphical user interface, a second indication from the user device indicating one or more selected assumption templates. Then, generate a third graphical user interface displaying the output template and transmit the third graphical user interface to the user device for display. The system may then receive, via the third graphical user interface, a third indication from the user device indicating a selected output configuration, calculate the data analysis using the one or more selected assumption templates and the first input data from the input template, and output the data analysis according to the third indication from the user device using the selected output configuration.

Disclosed embodiments may include a system for dynamically manipulating data. The system may include one or more processors, and memory in communication with the one or more processors and storing instructions that, when executed by the one or more processors, are configured to cause the system to provide dynamically manipulating data. The system may generate a first graphical user interface for indicating input data and transmit the first graphical user interface to a user device for display. The system may then receive, via the first graphical user interface, a first indication from the user device indicating a first selection of first input data and generate a second graphical user interface displaying an option of one or more assumption templates, each of the one or more assumption templates configured to perform a data analysis. Then, transmit the second graphical user interface to the user device for display and receive, via the second graphical user interface, a second indication from the user device indicating one or more selected assumption templates. The system may then process the first input data from the input data using one or more selected assumption templates to generate first output data, generate a third graphical user interface displaying the first output data, and transmit the third graphical user interface to the user device for display.

Disclosed embodiments may include a system for dynamically manipulating data. The system may include one or more processors, and memory in communication with the one or more processors and storing instructions that, when executed by the one or more processors, are configured to cause the system to provide dynamically manipulating data. The system may generate a first graphical user interface for indicating input data and transmit the first graphical user interface to a user device for display. The system may then receive, via the first graphical user interface, a first indication from the user device indicating a selection of first input data and receive or retrieve the first input data according to the selection of first input data of the first indication. Then, update the first graphical user interface to display the first input data and transmit the updated first graphical user interface to the user device for display. The system may then generate a second graphical user interface displaying an option of one or more assumption templates, each of the one or more assumption templates configured to perform a data analysis and transmit the second graphical user interface to the user device for display. The system may then receive, via the second graphical user interface, a second indication from the user device indicating one or more selected assumption templates and a selected output configuration and process the first input data from the input data using one or more selected assumption templates to generate first output data in the selected output configuration.

Further implementations, features, and aspects of the disclosed technology, and the advantages offered thereby, are described in greater detail hereinafter, and can be understood with reference to the following detailed description, accompanying drawings, and claims.

### BRIEF DESCRIPTION OF THE DRAWINGS

Reference will now be made to the accompanying drawings, which are not necessarily drawn to scale, and which illustrate various implementations, aspects, and principles of the disclosed technology. In the drawings:

FIG. 1 is a flow diagram illustrating an exemplary method for dynamically manipulating data in accordance with certain embodiments of the disclosed technology.

FIGS. 2A and 2B are flow diagrams illustrating additional exemplary methods for dynamically manipulating data in accordance with certain embodiments of the disclosed technology.

FIG. 3 is a block diagram of an example template system used to provide dynamically manipulated data, according to an example implementation of the disclosed technology.

FIG. 4 is a block diagram of an example system that may be used to provide dynamically manipulated data, according to an example implementation of the disclosed technology.

FIGS. 5A-5G are block diagrams of exemplary user interfaces for dynamically manipulating data, according to an example implementation of the disclosed technology.

### DETAILED DESCRIPTION

Examples of the present disclosure related to systems and methods for dynamically manipulating data. More particularly, the disclosed technology relates to a method for manipulating data using programming languages, templates, and graphical user interfaces. The systems and methods described herein utilize, in some instances, graphical user interfaces, which are necessarily rooted in computers and technology. Graphical user interfaces are a computer technology that allows for user interaction with computers through touch, pointing devices, or other means. The present disclosure details systems and methods for dynamically manipulating data. This, in some examples, may involve using input data, input templates, assumption templates, and selected output configurations to dynamically change the graphical user interface so that the system can calculate and output data analysis. This can further involve transforming data and performing complex analysis on the input data based on the selections from the graphical user interface. Using a graphical user interface in this way may allow the system to provide a flexible and simplified solution to analyzing data that gives users better control and visibility of the data and calculations. This is a clear advantage and improvement over prior technologies that require advanced technological resources to analyze data because tools that require advanced technological resources such as multiple programmers to analyze data can be costly and reduce visibility of data to users that are not technologically sophisticated. The present disclosure solves this problem by presenting graphical user interfaces to a user to generate dynamically manipulating data by automating processes with the use of templates of programming functions. Overall, the systems and methods disclosed have significant practical applications in the data analysis field because of the noteworthy improvements of the automation of manipulating data from the use of programming languages, which are important to solving present problems with this technology.

Some implementations of the disclosed technology will be described more fully with reference to the accompanying drawings. This disclosed technology may, however, be embodied in many different forms and should not be construed as limited to the implementations set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods.

Reference will now be made in detail to example embodiments of the disclosed technology that are illustrated in the accompanying drawings and disclosed herein. Wherever convenient, the same reference numbers will be used throughout the drawings to refer to the same or like parts.

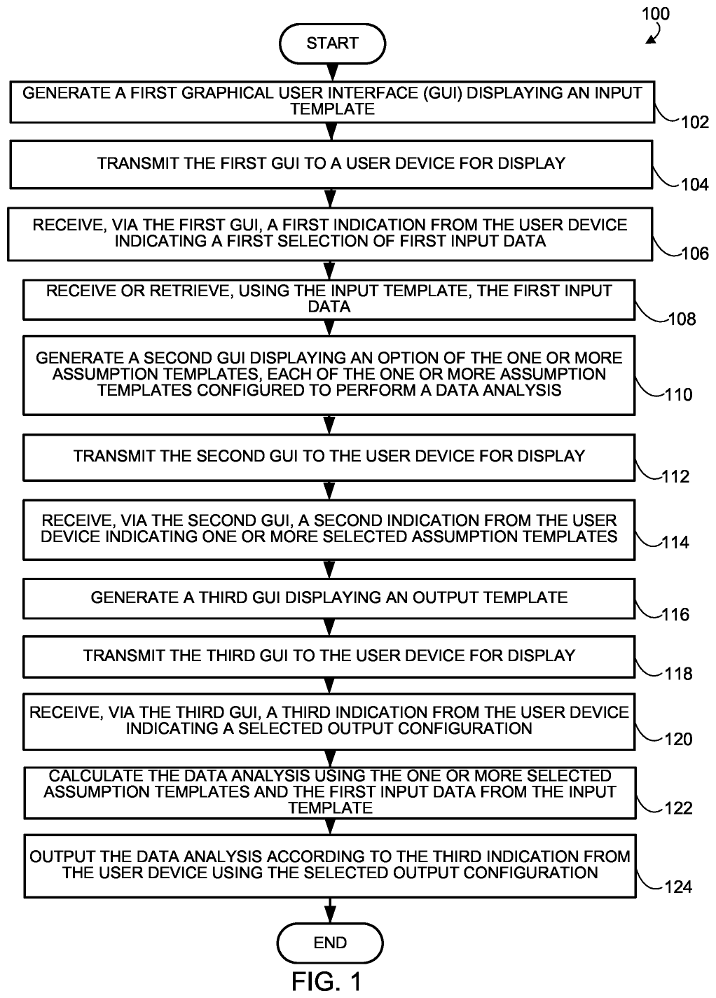

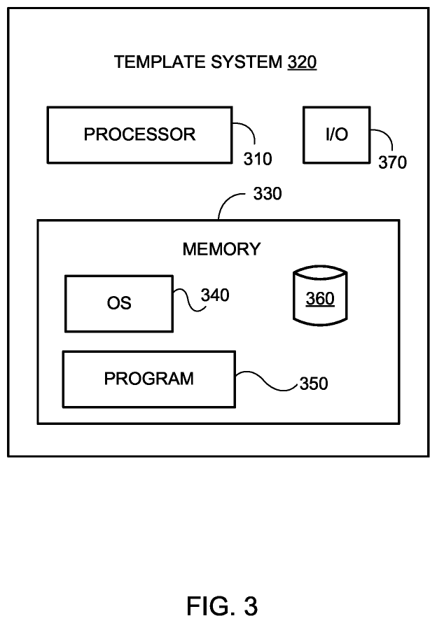

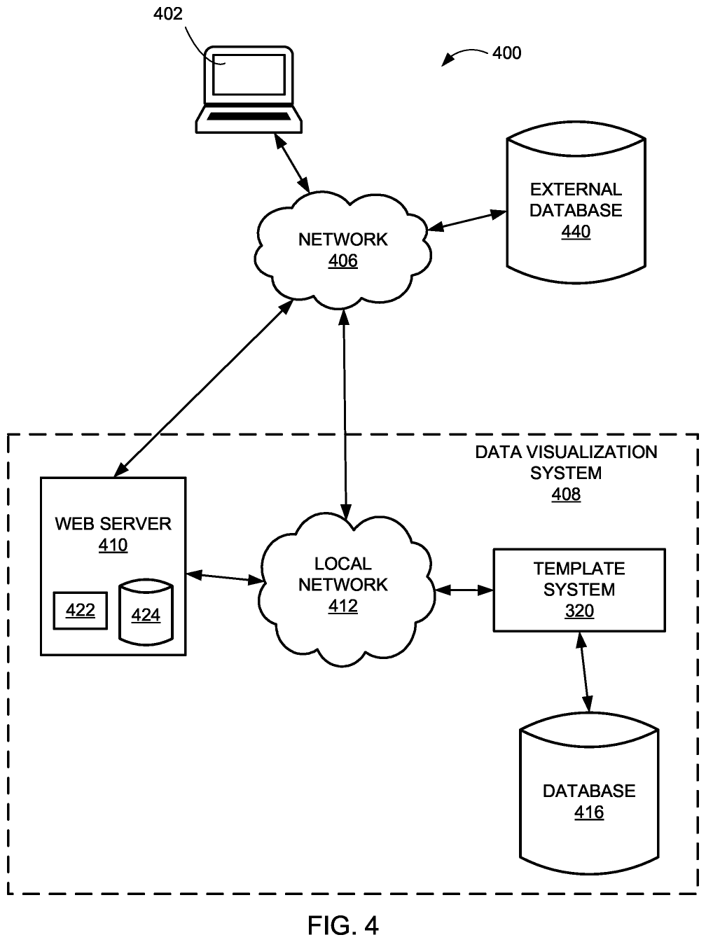

FIG. 1 is a flow diagram illustrating an exemplary method 100 for dynamically manipulating data, in accordance with certain embodiments of the disclosed technology. The steps of method 100 may be performed by one or more components of the system 400 (e.g., template system 320 or web server 410 of data manipulation system 408 or user device 402), as described in more detail with respect to FIGS. 3 and 4.

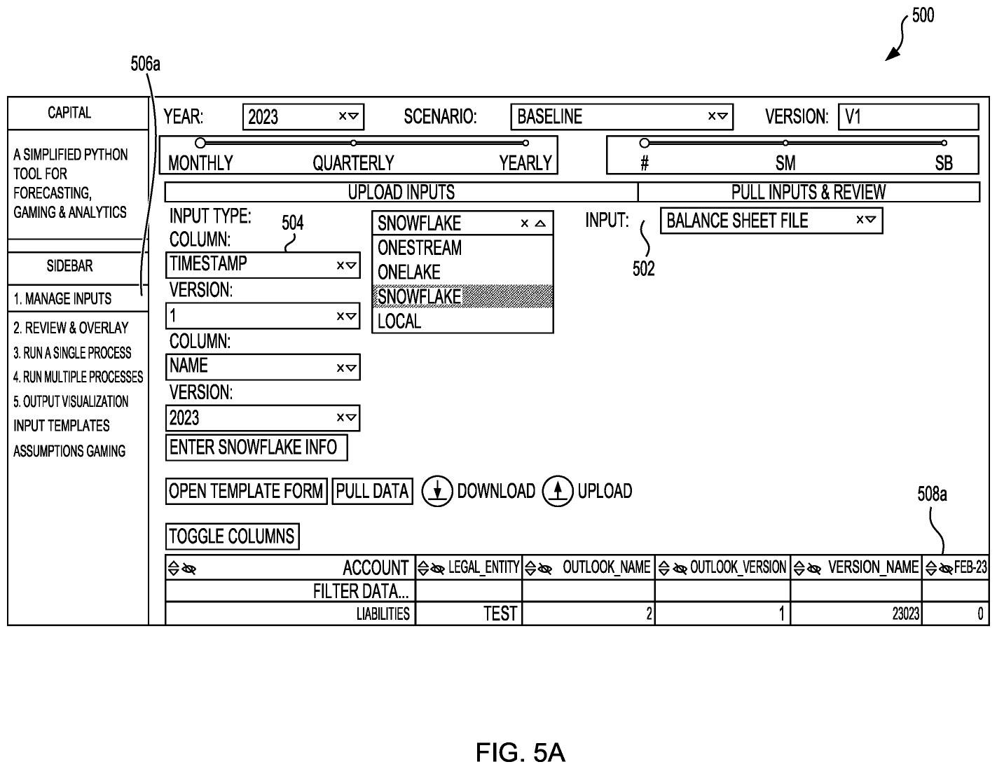

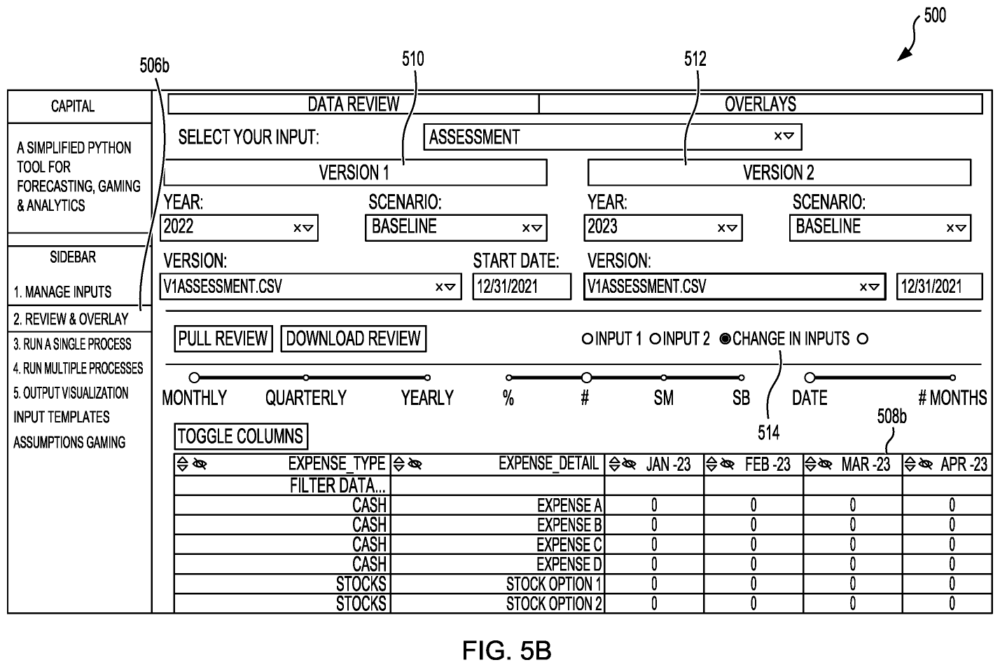

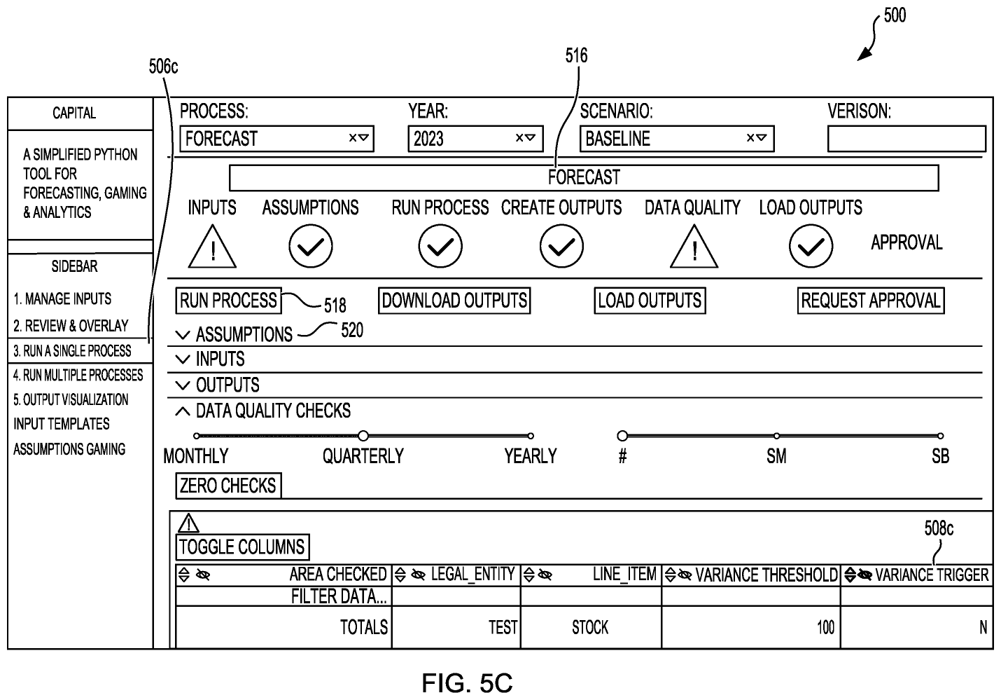

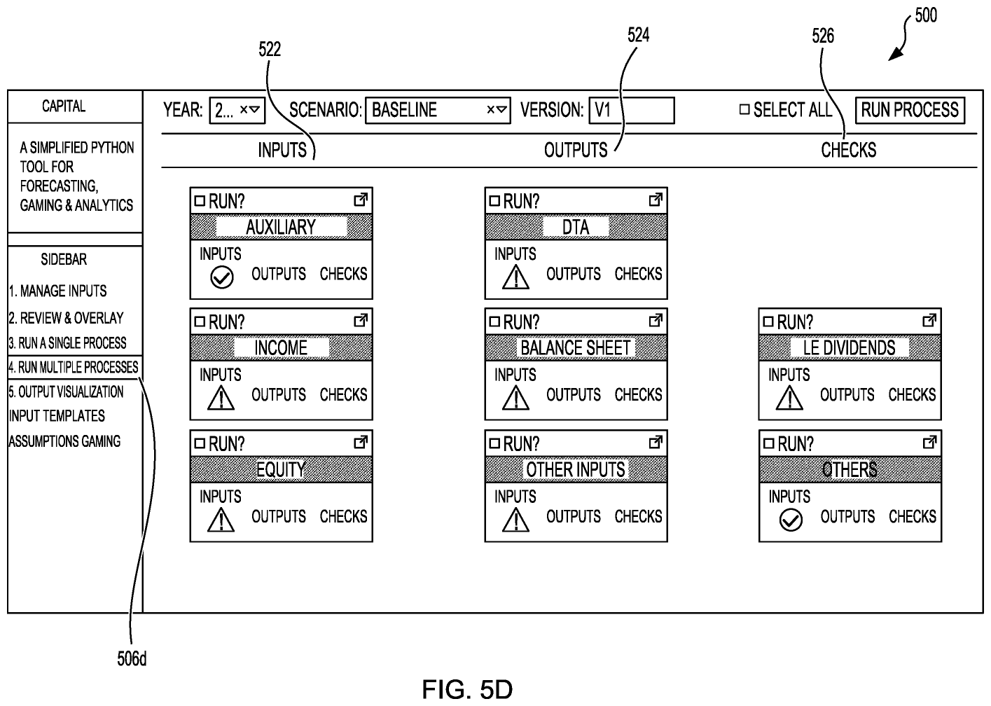

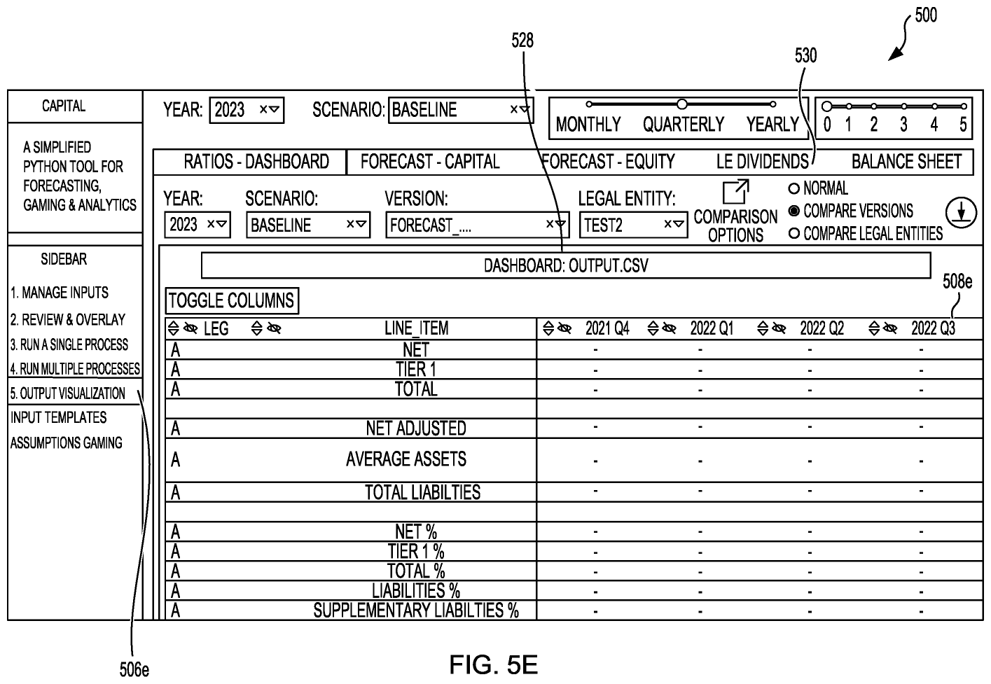

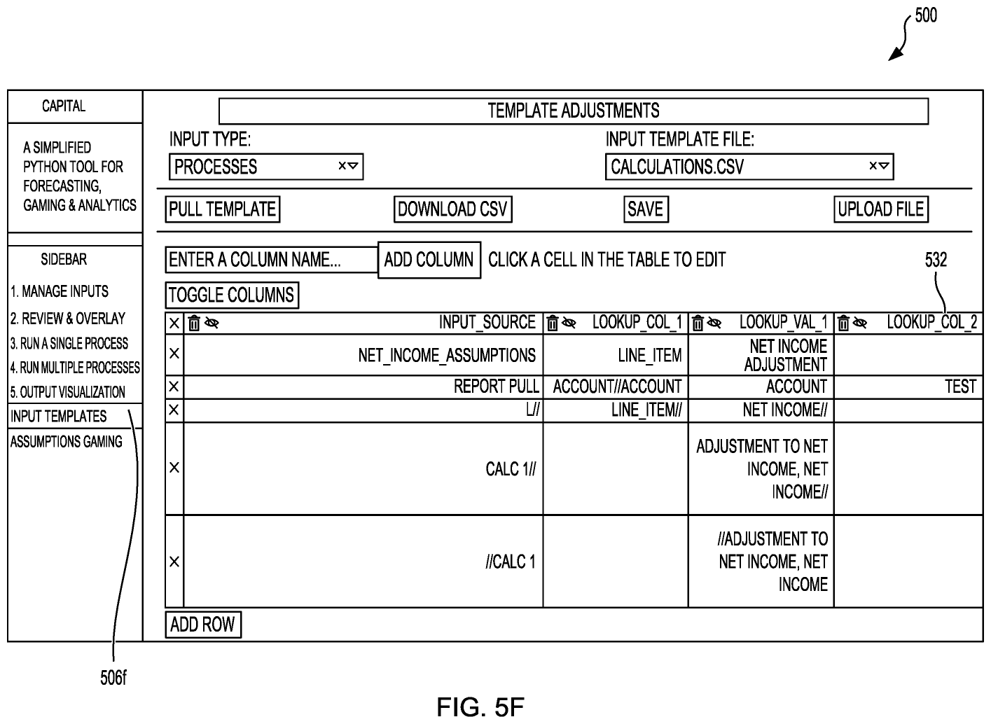

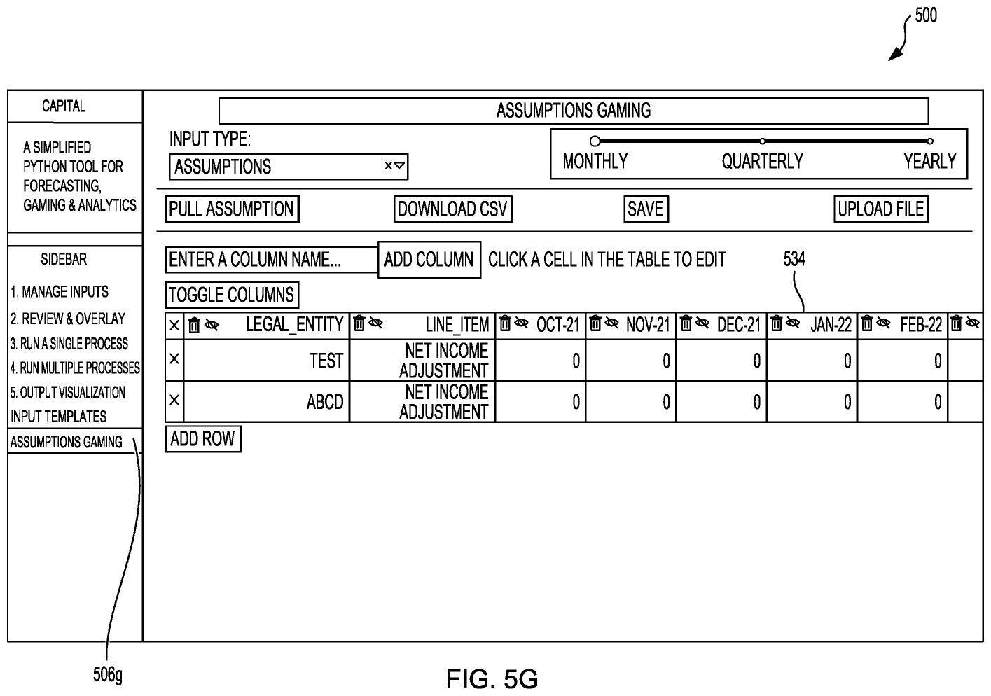

In block 102, the template system 320 may generate a first graphical user interface (GUI) 500 displaying an input template as illustrated in FIG. 5A. The first GUI 500 can include multiple regions, and each region can include sliding bar elements, buttons, dropdown elements. The first GUI 500 can include a sidebar region that includes a selectable list of steps from the method 100. As an example, a first item in the sidebar region can be used to manage input elements 506a. The first GUI 500 can further include a main region with additional buttons, dropdown elements, and a visual preview of first input data from the input template. In a non-limiting example illustrated in FIG. 5A, the first GUI 500 can include multiple dropdown elements to: select a version of an input file, a column from tabular data from the input file, or a data source that contains the input file.

In some embodiments, the first GUI 500 can include an option to select a historical run from a plurality of historical runs. The historical run can include historical data of historical input templates, historical selected assumption templates, historical output templates, and historical calculation templates. The historical run can include the historical input templates, the historical selected assumption templates, the historical output templates, and the historical calculation templates for a plurality of versions of the historical run. The template system 320 may transmit the first GUI 500 to a user device 402 for display. The template system 320 may receive, via the first GUI 500, a historical selection of the historical run from the plurality of historical runs. The template system 320 may then proceed through blocks 110 through 124 to prefilling selections with the historical data (historical templates such as historical input templates, historical selected assumption templates, historical output templates, and historical calculation templates) to allow the user device 402 to alter the historical templates previously used in the historical run. The user device 402 can also proceed to run a process using the same selections or historical templates from the historical run. As illustrated in FIG. 5B, the first GUI 500 can be modified to display a selection from the plurality of versions of the historical run if multiple versions are available. The first GUI 500 can include a first version 510 of the historical run displayed next to a second version 512 of the historical run.

In block 104, the template system 320 may transmit the first GUI 500 to a user device 402 for display. The first GUI 500 can include an upload button that once selected by a user through the user device 402, can cause the template system 320 to generate a splash screen that allows the user to navigate to a location of the input file to upload into the template system 320. The template system 320 can generate the splash screen based on the data source that contains the input file. For example, if the data source indicates that the input file is stored locally, then the template system 320 can generate the splash screen configured to allow the user to navigate through the directory on the local system of a device of the user for the input file.

In block 106, the template system 320 may receive, via the first GUI 500, a first indication from the user device 402 indicating a first selection of first input data. For example, the user can select the input file in the splash screen and can then select a column of the input file by selecting from a dropdown element of a column dropdown element 504. The first GUI 500 can display an input file name of the input file in an input element 502. The template system 320 may generate a preview of the tabular data from the input file in a table 508a of the first GUI 500. The user can verify that the correct input file is selected by reviewing the preview of the tabular data from the input file. It is understood that the first GUI 500 can include additional sliding bar elements and buttons to filter the tabular data from the input file, such as by a time period (e.g., monthly, quarterly, yearly, etc.). All elements and buttons in the first GUI 500 as illustrated in FIG. 5A can be prefilled with the first data from the input template. The first data in the input template can be predefined for the running of processes by the template system 320 prior to block 102. The template system 320 may generate the first GUI 500 to display available input templates to allow for the editing of the available input templates and for the addition of other input templates by the user device 402 as illustrated in FIG. 5F. In other examples, the user can make selections for the elements and buttons through the first GUI 500, and each of the selections can be included in the input template.

In block 108, the template system 320 may receive or retrieve, using the input template, the first input data. As outlined in block 106, the elements and buttons in the first GUI 500 can be prefilled with the first input data from the input template. The input template can include a separate location that is storing the first input data. The template system 320 can retrieve the first input data from the separate location included in the input template. If the user selects a location of the input file through the splash screen, the template system 320 can retrieve the first input data from the location received from the user device 402 by the splash screen.

In some examples, the template system 320 can modify the first GUI 500 based on the first indication from the user device indicating the first selection of the first input data to generate a review and overlay preview as illustrated in FIG. 5B. As illustrated, the sidebar region can include a review and overlay preview selection 506b. After the first selection of the first input data is selected by the user, the main region of the first GUI 500 can be modified to display multiple versions of the input file if multiple versions are available. A first GUI 500 can include a first version 510 of the input file displayed next to a second version 512 of the input file. The template system can modify table 508a of the first GUI 500 to display a table 508b of differences between the first version 510 of the input file and the second version 512. Additional dropdown elements, sliding bar elements and buttons can be included in the main region to allow a user to filter the first input data. In one example, the first GUI 500 can include a change inputs button 514 configured to allow the user to make another selection for the first input data, such as selecting a different input file or a different column of the first input data. The template system 320 can alter the data displayed in table 508b based on the change of input or a selected filter from the user device 402.

In block 110, the template system 320 may generate a second GUI 500 displaying an option of the one or more assumption templates, each of the one or more assumption templates can include one or more parameters based on the first selection of the first input data. The template system 320 may modify the second GUI 500 to display the one or more assumption templates to allow the user via the user device 402 to modify the one or more assumption templates (directly or through the second GUI 500 via selections) or to add additional assumption templates as illustrated in FIG. 5G. In some embodiments, the template system 320 can use one or more calculation templates configured to perform a data analysis. Each of the one or more calculation templates can be configured to perform the data analysis by including programming functions in a programming language. The programming functions can be modules of code that the template system 320 can use to accomplish specific data analysis tasks. Each programming function can include instructions using parameters from the one or more assumption templates and can be configured to generate output for the template system 320. As illustrated in FIG. 5C, the second GUI 500 can include the sidebar region with a selection to run a process 506c. The second GUI 500 can include the main region with a collapsible region 520 that displays the one or more assumption templates.

In block 112, the template system 320 may transmit the second graphical user interface to the user device 402 for display. As illustrated in FIG. 5C, the second GUI 500 can include buttons to begin running a process, download outputs, load outputs, or request an approval for a process. The second GUI 500 can include a progress region 516 with indicators that are configured to notify the user of an issue with a step of the process. In a non-limiting example illustrated in FIG. 5C, the progress region 516 can display that the template system 320 detected an issue with inputs and data quality of the process and successfully processed assumptions, created, and loaded the outputs, and ran the process. In one example, the template system 320 can verify there is data quality by ensuring that the first data input is compatible with the one or more assumption templates. The template system 320 can use a machine learning model to preselect the one or more assumption templates based on the first data input. The machine learning model can be trained using a training set of data input mapped to correct assumption templates.

In block 114, the template system 320 may receive, via the second GUI 500, a second indication from the user device 402 indicating one or more selected assumption templates. If template system 320, using the machine learning model, preselects incorrect assumption templates, the template system 320 can retrain the machine learning model using the first data input and the one or more selected assumption templates. When the user, via the user device 402 selects a run process button 518, the template system may use the first data inputs, the one or more selected assumption templates, and the one or more calculation templates to generate data analysis for first output data by taking the parameters from the one or more selected assumption templates that are based on the first data inputs and inputting the parameters into the programming functions in the one or more calculations template. The programming functions may then return data analysis to the template system 320. The template system 320 may then modify the second GUI 500 to display an output table 508c including the data analysis. The second GUI 500 can include sliding bar elements to filter the data in the output table 508c. The progress region 516 can be modified to display different indicator statuses after the template system 320 generates the first output data. The template system 320 can send the first output data to the user device 402 if the user selects a download output button. The second GUI 500 can include additional buttons and drop down elements to view and modify the first input data and first output data.

In other examples, the template system 320 may receive, via the second GUI 500, the second indication from the user device 402 indicating one or more predefined processes as illustrated in FIG. 5D. Each of the one or more predefined processes can include a predefined location with a predefined input file. When the template system 320 receives the second indication from the user device 402 of selected one or more predefined processes, the template system 320 can run the selected one or more predefined processes using predefined input data from the predefined input file. The template system 320 can run each of the selected one or more predefined processes sequentially without further input from the user between each process. The second GUI 500 can organize the one or more predefined processes into categories such as inputs 522, outputs 524, checks 526 to the present to the user as illustrated in FIG. 5D.

In block 116, the template system 320 may generate a third GUI 500 displaying an output template. The third GUI 500 can include a preview output table 508e of the data analysis. The third GUI 500 can further include a header region 530 with one or more visualization options. The third GUI 500 can also further include additional interactive elements and buttons as illustrated in FIG. 5D (e.g., output file name 528). The interactive elements can include sliding bars for filtering the data analysis displayed on the output table 508c. The interactive elements can include a download button configured to store the first output data as an output file using the output file name 528.

In block 118, the template system 320 may transmit the third GUI 500 to the user device 402 for display and in block 120, the template system 320 may receive, via the third GUI 500, a third indication from the user device indicating a selected output configuration from the output template. The output template can include a selection of output configurations. The output configurations can each include programming functions that are configured to display visualizations of the data analysis. In one or more non-limiting examples, the output configuration may include calls to a Tableau server configured to create visualizations of the data analysis.

In block 122, the template system 320 may calculate the data analysis using the one or more selected assumption templates and the first input data from the input template. The template system 320 may calculate the data analysis using programming language functions associated with the one or more selected assumption templates. The template system 320 may use the first input data as parameters in the programming language functions. The template system 320 can make calls to the programming language functions. The programming language functions can be stored on online libraries or locally in memory 330.

In block 124, the template system 320 may output the data analysis according to the third indication from the user device 402 using the selected output configuration. The template system 320 may call the programming language functions associated with the selected output configuration such as calls to Tableau functions to generate visualizations of the data analysis. The template system 320 may modify the third GUI 500 to display the visualizations or data analysis. The template system 320 may also store the visualizations or data analysis in a selected location from the user device 402. The template system 320 may store the data analysis in a tabular format in the output file.

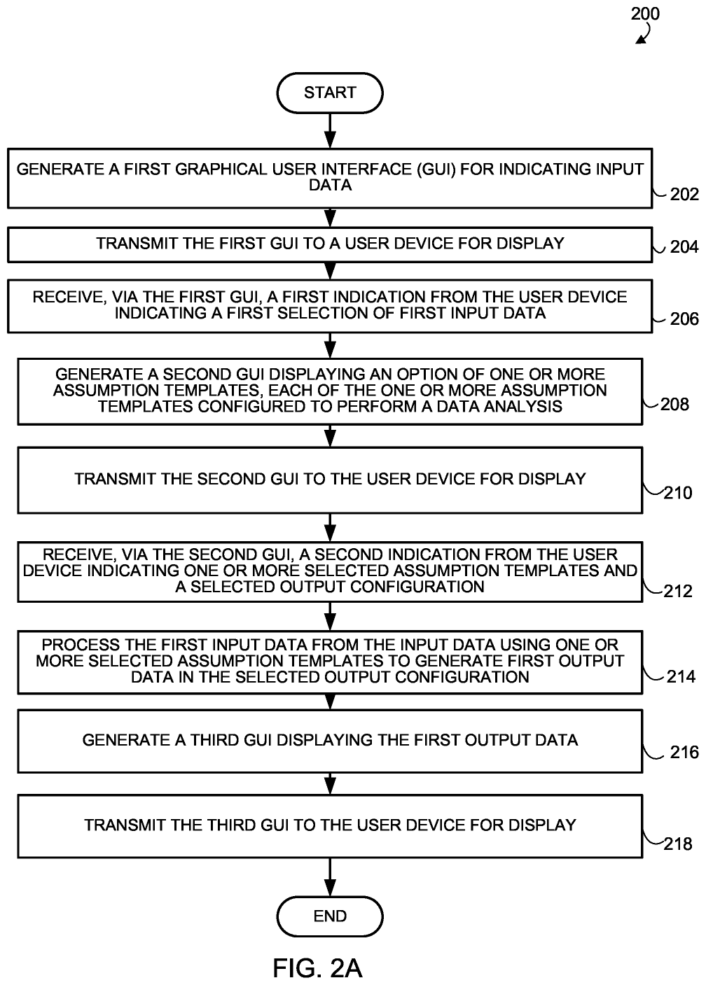

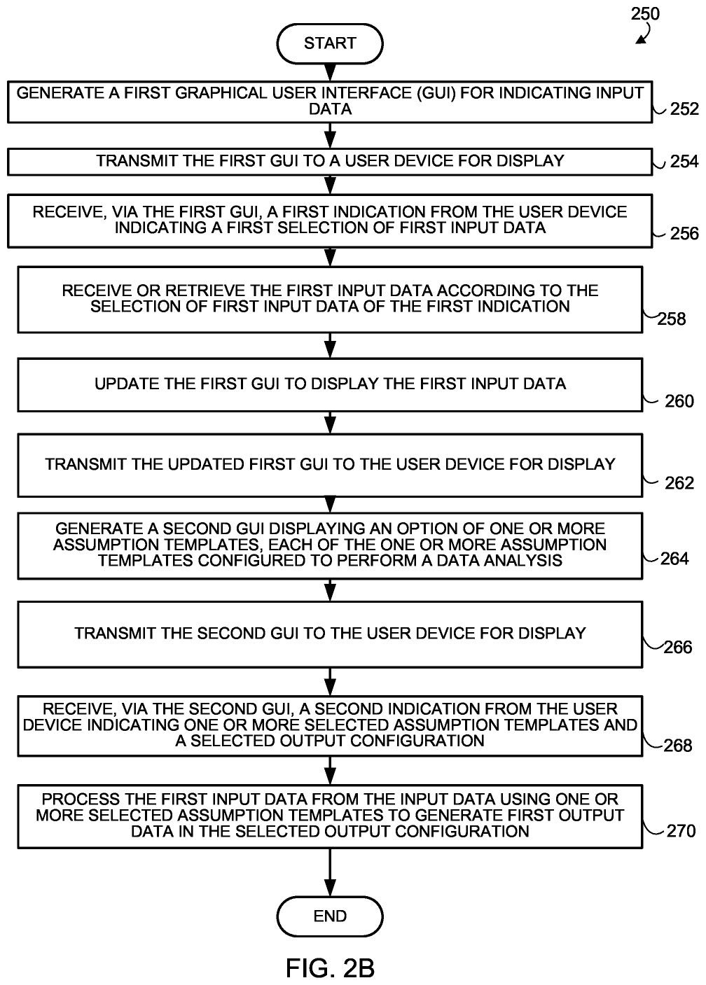

FIGS. 2A and 2B are flow diagrams illustrating exemplary methods 200 and 250 for dynamically manipulating data, in accordance with certain embodiments of the disclosed technology. The steps of methods 200 and 250 may be performed by one or more components of the system 400 (e.g., template system 320 or web server 410 of data manipulation system 408 or user device 402), as described in more detail with respect to FIGS. 3 and 4.

Method 200 of FIG. 2A is similar to method 100 of FIG. 1, except that method 200 may not include blocks 108, 120, 122, and 124 of method 100. The descriptions of blocks 202, 204, 206, 208, 210, and 218 are similar to the respective descriptions of blocks 102, 104, 106, 110, 112, and 118 of method 100 and are not repeated herein for brevity. However, block 212 is different from block 114 and is described below. Additional block 214 is also described below.

In block 212, the template system 320 may receive, via the second GUI 500, a second indication from the user device 402 indicating one or more selected assumption templates and a selected output configuration. The template system 320 may receive the one or more selected assumption templates as outlined in block 114 in method 100 above. Additionally, the template system 320 may receive the selected output configuration as outlined in block 120 in method 100 above. However, in block 212 of method 200, the template system 320 may receive the one or more selected assumption templates in conjunction with the selected output configuration.

In block 214, the template system 320 may process the first input data from the input data using one or more selected assumption templates to generate first output data in the selected output configuration. The template system 320 may process the first input data by using programming language functions associated with the one or more selected assumption templates. The template system 320 may use the first input data as parameters in the programming language functions. The programming language functions may generate first output data using the first input data as parameters. The template system 320 can make calls to the programming language functions. The programming language functions can be stored on online libraries or locally in memory 330. The template system 320 may call visualization programming language functions associated with the selected output configuration such as calls to Tableau functions to generate visualizations of the data analysis. The template system 320 may modify the second GUI 500 to display the visualizations or data analysis. The template system 320 may also store the visualizations or data analysis in a selected location from the user device 402. The template system 320 may store the data analysis in a tabular format in the output file.

In block 216, the template system 320 may generate a third GUI 500 displaying the first output data. The third GUI 500 can include a preview output table 508e of the first output data as illustrated in FIG. 5D. The third GUI 500 can further include a header region 530 with one or more visualization options. The third GUI 500 can also further include additional interactive elements and buttons as illustrated in FIG. 5D (e.g., output file name 528). The interactive elements can include sliding bars for filtering the first output data displayed on the output table 508c. The interactive elements can include a download button configured to store the first output data as an output file using the output file name 528.

Method 250 of FIG. 2B is similar to method 100 of FIG. 1, except that method 200 may not include blocks 114, 116, 118, 120, 122, and 124 of method 100. The descriptions of blocks 252, 254, 256, 258, 262, 264, and 266 are similar to the respective descriptions of blocks 102, 104, 106, 104, 108, 110, and 112 of method 100 and are not repeated herein for brevity. Method 250 of FIG. 2B is also similar to method 200 of FIG. 2A. The descriptions of blocks 268 and 270 are similar to the respective descriptions of blocks 212 and 214 of method 200 and are not repeated herein for brevity. However, block 258 is different from block 108 of method 100 of FIG. 1, block 260 is different from block 102 of method 100 of FIG. 1 and are described below.

In block 260, the template system 320 may update the first GUI 500 to display the first input data. The template system 320 may generate a preview of the first input data in a table 508a of the first GUI 500. The user can verify that the correct input file is selected by reviewing the preview of the first input data. It is understood that the first GUI 500 can include additional sliding bar elements and buttons to filter the first input data from the input file, such as by a time period (e.g., monthly, quarterly, yearly, etc.). All elements and buttons in the first GUI 500 as illustrated in FIG. 5A can be prefilled with the first input data.

FIG. 3 is a block diagram of an example template system 320 used for dynamically manipulating data according to an example implementation of the disclosed technology. According to some embodiments, the user device 402 and web server 410, as depicted in FIG. 4 and described below, may have a similar structure and components that are similar to those described with respect to template system 320 shown in FIG. 3. As shown, the template system 320 may include a processor 310, an input/output (I/O) device 370, a memory 330 containing an operating system (OS) 340 and a program 350. In certain example implementations, the template system 320 may be a single server or may be configured as a distributed computer system including multiple servers or computers that interoperate to perform one or more of the processes and functionalities associated with the disclosed embodiments. In some embodiments template system 320 may be one or more servers from a serverless or scaling server system. In some embodiments, the template system 320 may further include a peripheral interface, a transceiver, a mobile network interface in communication with the processor 310, a bus configured to facilitate communication between the various components of the template system 320, and a power source configured to power one or more components of the template system 320.

A peripheral interface, for example, may include the hardware, firmware and/or software that enable(s) communication with various peripheral devices, such as media drives (e.g., magnetic disk, solid state, or optical disk drives), other processing devices, or any other input source used in connection with the disclosed technology. In some embodiments, a peripheral interface may include a serial port, a parallel port, a general-purpose input and output (GPIO) port, a game port, a universal serial bus (USB), a micro-USB port, a high-definition multimedia interface (HDMI) port, a video port, an audio port, a Bluetooth™ port, a near-field communication (NFC) port, another like communication interface, or any combination thereof.

In some embodiments, a transceiver may be configured to communicate with compatible devices and ID tags when they are within a predetermined range. A transceiver may be compatible with one or more of: radio-frequency identification (RFID), near-field communication (NFC), Bluetooth™, low-energy Bluetooth™ (BLE), WiFi™, ZigBee™, ambient backscatter communications (ABC) protocols or similar technologies.

A mobile network interface may provide access to a cellular network, the Internet, or another wide-area or local area network. In some embodiments, a mobile network interface may include hardware, firmware, and/or software that allow(s) the processor(s) 310 to communicate with other devices via wired or wireless networks, whether local or wide area, private or public, as known in the art. A power source may be configured to provide an appropriate alternating current (AC) or direct current (DC) to power components.

The processor 310 may include one or more of a microprocessor, microcontroller, digital signal processor, co-processor or the like or combinations thereof capable of executing stored instructions and operating upon stored data. The memory 330 may include, in some implementations, one or more suitable types of memory (e.g. such as volatile or non-volatile memory, random access memory (RAM), read only memory (ROM), programmable read-only memory (PROM), erasable programmable read-only memory (EPROM), electrically erasable programmable read-only memory (EEPROM), magnetic disks, optical disks, floppy disks, hard disks, removable cartridges, flash memory, a redundant array of independent disks (RAID), and the like), for storing files including an operating system, application programs (including, for example, a web browser application, a widget or gadget engine, and or other applications, as necessary), executable instructions and data. In one embodiment, the processing techniques described herein may be implemented as a combination of executable instructions and data stored within the memory 330.

The processor 310 may be one or more known processing devices, such as, but not limited to, a microprocessor from the Core™ family manufactured by Intel™, the Ryzen™ family manufactured by AMD™, or a system-on-chip processor using an ARM™ or other similar architecture. The processor 310 may constitute a single core or multiple core processor that executes parallel processes simultaneously, a central processing unit (CPU), an accelerated processing unit (APU), a graphics processing unit (GPU), a microcontroller, a digital signal processor (DSP), a field-programmable gate array (FPGA), an application-specific integrated circuit (ASIC) or another type of processing component. For example, the processor 310 may be a single core processor that is configured with virtual processing technologies. In certain embodiments, the processor 310 may use logical processors to simultaneously execute and control multiple processes. The processor 310 may implement virtual machine (VM) technologies, or other similar known technologies to provide the ability to execute, control, run, manipulate, store, etc. multiple software processes, applications, programs, etc. One of ordinary skill in the art would understand that other types of processor arrangements could be implemented that provide for the capabilities disclosed herein.

In accordance with certain example implementations of the disclosed technology, the template system 320 may include one or more storage devices configured to store information used by the processor 310 (or other components) to perform certain functions related to the disclosed embodiments. In one example, the template system 320 may include the memory 330 that includes instructions to enable the processor 310 to execute one or more applications, such as server applications, network communication processes, and any other type of application or software known to be available on computer systems. Alternatively, the instructions, application programs, etc. may be stored in an external storage or available from a memory over a network. The one or more storage devices may be a volatile or non-volatile, magnetic, semiconductor, tape, optical, removable, non-removable, or other type of storage device or tangible computer-readable medium.

The template system 320 may include a memory 330 that includes instructions that, when executed by the processor 310, perform one or more processes consistent with the functionalities disclosed herein. Methods, systems, and articles of manufacture consistent with disclosed embodiments are not limited to separate programs or computers configured to perform dedicated tasks. For example, the template system 320 may include the memory 330 that may include one or more programs 350 to perform one or more functions of the disclosed embodiments. For example, in some embodiments, the template system 320 may additionally manage dialogue and/or other interactions with the customer via a program 350.

The processor 310 may execute one or more programs 350 located remotely from the template system 320. For example, the template system 320 may access one or more remote programs that, when executed, perform functions related to disclosed embodiments.

The memory 330 may include one or more memory devices that store data and instructions used to perform one or more features of the disclosed embodiments. The memory 330 may also include any combination of one or more databases controlled by memory controller devices (e.g., server(s), etc.) or software, such as document management systems, Microsoft™ SQL databases, SharePoint™ databases, Oracle™ databases, Sybase™ databases, or other relational or non-relational databases. The memory 330 may include software components that, when executed by the processor 310, perform one or more processes consistent with the disclosed embodiments. In some embodiments, the memory 330 may include a template system database 360 for storing related data to enable the template system 320 to perform one or more of the processes and functionalities associated with the disclosed embodiments.

The template system database 360 may include stored data relating to status data (e.g., average session duration data, location data, idle time between sessions, and/or average idle time between sessions) and historical status data. According to some embodiments, the functions provided by the template system database 360 may also be provided by a database that is external to the template system 320, such as the database 416 and external database 440 as shown in FIG. 4.

The template system 320 may also be communicatively connected to one or more memory devices (e.g., databases) locally or through a network. The remote memory devices may be configured to store information and may be accessed and/or managed by the template system 320. By way of example, the remote memory devices may be document management systems, Microsoft™ SQL database, SharePoint™ databases, Oracle™ databases, Sybase™ databases, or other relational or non-relational databases. Systems and methods consistent with disclosed embodiments, however, are not limited to separate databases or even to the use of a database.

The template system 320 may also include one or more I/O devices 370 that may comprise one or more interfaces for receiving signals or input from devices and providing signals or output to one or more devices that allow data to be received and/or transmitted by the template system 320. For example, the template system 320 may include interface components, which may provide interfaces to one or more input devices, such as one or more keyboards, mouse devices, touch screens, track pads, trackballs, scroll wheels, digital cameras, microphones, sensors, and the like, that enable the template system 320 to receive data from a user (such as, for example, via the user device 402).

In examples of the disclosed technology, the template system 320 may include any number of hardware and/or software applications that are executed to facilitate any of the operations. The one or more I/O interfaces may be utilized to receive or collect data and/or user instructions from a wide variety of input devices. Received data may be processed by one or more computer processors as desired in various implementations of the disclosed technology and/or stored in one or more memory devices.

The template system 320 may contain programs that train, implement, store, receive, retrieve, and/or transmit one or more machine learning models. Machine learning models may include a neural network model, a generative adversarial model (GAN), a recurrent neural network (RNN) model, a deep learning model (e.g., a long short-term memory (LSTM) model), a random forest model, a convolutional neural network (CNN) model, a support vector machine (SVM) model, logistic regression, XGBoost, and/or another machine learning model. Models may include an ensemble model (e.g., a model comprised of a plurality of models). In some embodiments, training of a model may terminate when a training criterion is satisfied. Training criterion may include a number of epochs, a training time, a performance metric (e.g., an estimate of accuracy in reproducing test data), or the like. The template system 320 may be configured to adjust model parameters during training. Model parameters may include weights, coefficients, offsets, or the like. Training may be supervised or unsupervised.

The template system 320 may be configured to train machine learning models by optimizing model parameters and/or hyperparameters (hyperparameter tuning) using an optimization technique, consistent with disclosed embodiments. Hyperparameters may include training hyperparameters, which may affect how training of the model occurs, or architectural hyperparameters, which may affect the structure of the model. An optimization technique may include a grid search, a random search, a gaussian process, a Bayesian process, a Covariance Matrix Adaptation Evolution Strategy (CMA-ES), a derivative-based search, a stochastic hill-climb, a neighborhood search, an adaptive random search, or the like. The template system 320 may be configured to optimize statistical models using known optimization techniques.

Furthermore, the template system 320 may include programs configured to retrieve, store, and/or analyze properties of data models and datasets. For example, template system 320 may include or be configured to implement one or more data-profiling models. A data-profiling model may include machine learning models and statistical models to determine the data schema and/or a statistical profile of a dataset (e.g., to profile a dataset), consistent with disclosed embodiments. A data-profiling model may include an RNN model, a CNN model, or other machine-learning model.

The template system 320 may include algorithms to determine a data type, key-value pairs, row-column data structure, statistical distributions of information such as keys or values, or other property of a data schema may be configured to return a statistical profile of a dataset (e.g., using a data-profiling model). The template system 320 may be configured to implement univariate and multivariate statistical methods. The template system 320 may include a regression model, a Bayesian model, a statistical model, a linear discriminant analysis model, or other classification model configured to determine one or more descriptive metrics of a dataset. For example, template system 320 may include algorithms to determine an average, a mean, a standard deviation, a quantile, a quartile, a probability distribution function, a range, a moment, a variance, a covariance, a covariance matrix, a dimension and/or dimensional relationship (e.g., as produced by dimensional analysis such as length, time, mass, etc.) or any other descriptive metric of a dataset.

The template system 320 may be configured to return a statistical profile of a dataset (e.g., using a data-profiling model or other model). A statistical profile may include a plurality of descriptive metrics. For example, the statistical profile may include an average, a mean, a standard deviation, a range, a moment, a variance, a covariance, a covariance matrix, a similarity metric, or any other statistical metric of the selected dataset. In some embodiments, template system 320 may be configured to generate a similarity metric representing a measure of similarity between data in a dataset. A similarity metric may be based on a correlation, covariance matrix, a variance, a frequency of overlapping values, or other measure of statistical similarity.

The template system 320 may be configured to generate a similarity metric based on data model output, including data model output representing a property of the data model. For example, template system 320 may be configured to generate a similarity metric based on activation function values, embedding layer structure and/or outputs, convolution results, entropy, loss functions, model training data, or other data model output). For example, a synthetic data model may produce first data model output based on a first dataset and a produced data model output based on a second dataset, and a similarity metric may be based on a measure of similarity between the first data model output and the second-data model output. In some embodiments, the similarity metric may be based on a correlation, a covariance, a mean, a regression result, or other similarity between a first data model output and a second data model output. Data model output may include any data model output as described herein or any other data model output (e.g., activation function values, entropy, loss functions, model training data, or other data model output). In some embodiments, the similarity metric may be based on data model output from a subset of model layers. For example, the similarity metric may be based on data model output from a model layer after model input layers or after model embedding layers. As another example, the similarity metric may be based on data model output from the last layer or layers of a model.

The template system 320 may be configured to classify a dataset. Classifying a dataset may include determining whether a dataset is related to another datasets. Classifying a dataset may include clustering datasets and generating information indicating whether a dataset belongs to a cluster of datasets. In some embodiments, classifying a dataset may include generating data describing the dataset (e.g., a dataset index), including metadata, an indicator of whether data element includes actual data and/or synthetic data, a data schema, a statistical profile, a relationship between the test dataset and one or more reference datasets (e.g., node and edge data), and/or other descriptive information. Edge data may be based on a similarity metric. Edge data may indicate a similarity between datasets and/or a hierarchical relationship (e.g., a data lineage, a parent-child relationship). In some embodiments, classifying a dataset may include generating graphical data, such as anode diagram, a tree diagram, or a vector diagram of datasets. Classifying a dataset may include estimating a likelihood that a dataset relates to another dataset, the likelihood being based on the similarity metric.

The template system 320 may include one or more data classification models to classify datasets based on the data schema, statistical profile, and/or edges. A data classification model may include a convolutional neural network, a random forest model, a recurrent neural network model, a support vector machine model, or another machine learning model. A data classification model may be configured to classify data elements as actual data, synthetic data, related data, or any other data category. In some embodiments, template system 320 is configured to generate and/or train a classification model to classify a dataset, consistent with disclosed embodiments.

The template system 320 may also contain one or more prediction models. Prediction models may include statistical algorithms that are used to determine the probability of an outcome, given a set amount of input data. For example, prediction models may include regression models that estimate the relationships among input and output variables. Prediction models may also sort elements of a dataset using one or more classifiers to determine the probability of a specific outcome. Prediction models may be parametric, non-parametric, and/or semi-parametric models.

In some examples, prediction models may cluster points of data in functional groups such as “random forests.” Random Forests may comprise combinations of decision tree predictors. (Decision trees may comprise a data structure mapping observations about something, in the “branch” of the tree, to conclusions about that thing's target value, in the “leaves” of the trec.) Each trec may depend on the values of a random vector sampled independently and with the same distribution for all trees in the forest. Prediction models may also include artificial neural networks. Artificial neural networks may model input/output relationships of variables and parameters by generating a number of interconnected nodes which contain an activation function. The activation function of a node may define a resulting output of that node given an argument or a set of arguments. Artificial neural networks may generate patterns to the network via an ‘input layer’, which communicates to one or more “hidden layers” where the system determines regressions via one or more weighted connections. Prediction models may additionally or alternatively include classification and regression trees, or other types of models known to those skilled in the art. To generate prediction models, the template system may analyze information applying machine-learning methods.

While the template system 320 has been described as one form for implementing the techniques described herein, other, functionally equivalent, techniques may be employed. For example, some or all of the functionality implemented via executable instructions may also be implemented using firmware and/or hardware devices such as application specific integrated circuits (ASICs), programmable logic arrays, state machines, etc. Furthermore, other implementations of the template system 320 may include a greater or lesser number of components than those illustrated.

FIG. 4 is a block diagram of an example system that may be used to view and interact with data manipulation system 408, according to an example implementation of the disclosed technology. The components and arrangements shown in FIG. 4 are not intended to limit the disclosed embodiments as the components used to implement the disclosed processes and features may vary. As shown, data manipulation system 408 may interact with a user device 402 via a network 406. In certain example implementations, the data manipulation system 408 may include a local network 412, a template system 320, a web server 410, and a database 416.

In some embodiments, a user may operate the user device 402. The user device 402 can include one or more of a mobile device, smart phone, general purpose computer, tablet computer, laptop computer, telephone, public switched telephone network (PSTN) landline, smart wearable device, voice command device, other mobile computing device, or any other device capable of communicating with the network 406 and ultimately communicating with one or more components of the data manipulation system 408. In some embodiments, the user device 402 may include or incorporate electronic communication devices for hearing or vision impaired users.

According to some embodiments, the user device 402 may include an environmental sensor for obtaining audio or visual data, such as a microphone and/or digital camera, a geographic location sensor for determining the location of the device, an input/output device such as a transceiver for sending and receiving data, a display for displaying digital images, one or more processors, and a memory in communication with the one or more processors.

The template system 320 may include programs (scripts, functions, algorithms) to configure data for visualizations and provide visualizations of datasets and data models on the user device 402. This may include programs to generate graphs and display graphs. The template system 320 may include programs to generate histograms, scatter plots, time series, or the like on the user device 402. The template system 320 may also be configured to display properties of data models and data model training results including, for example, architecture, loss functions, cross entropy, activation function values, embedding layer structure and/or outputs, convolution results, node outputs, or the like on the user device 402.

The network 406 may be of any suitable type, including individual connections via the internet such as cellular or WiFi networks. In some embodiments, the network 406 may connect terminals, services, and mobile devices using direct connections such as radio-frequency identification (RFID), near-field communication (NFC), Bluetooth™, low-energy Bluetooth™ (BLE), WiFi™, ZigBee™, ambient backscatter communications (ABC) protocols, USB, WAN, or LAN. Because the information transmitted may be personal or confidential, security concerns may dictate one or more of these types of connections be encrypted or otherwise secured. In some embodiments, however, the information being transmitted may be less personal, and therefore the network connections may be selected for convenience over security.

The network 406 may include any type of computer networking arrangement used to exchange data. For example, the network 406 may be the Internet, a private data network, virtual private network (VPN) using a public network, and/or other suitable connection(s) that enable(s) components in the system 400 environment to send and receive information between the components of the system 400. The network 406 may also include a PSTN and/or a wireless network.

The data manipulation system 408 may be associated with and optionally controlled by one or more entities such as a business, corporation, individual, partnership, or any other entity that provides one or more of goods, services, and consultations to individuals such as customers. In some embodiments, the data manipulation system 408 may be controlled by a third party on behalf of another business, corporation, individual, partnership, etc. The data manipulation system 408 may include one or more servers and computer systems for performing one or more functions associated with products and/or services that the organization provides.

Web server 410 may include a computer system configured to generate and provide one or more websites accessible to customers, as well as any other individuals involved in access system 408's normal operations. Web server 410 may include a computer system configured to receive communications from user device 402 via, for example, a mobile application, a chat program, an instant messaging program, a voice-to-text program, an SMS message, email, or any other type or format of written or electronic communication. Web server 410 may have one or more processors 422 and one or more web server databases 424, which may be any suitable repository of website data. Information stored in web server 410 may be accessed (e.g., retrieved, updated, and added to) via local network 412 and/or network 406 by one or more devices or systems of system 400. In some embodiments, web server 410 may host websites or applications that may be accessed by the user device 402. For example, web server 410 may host a financial service provider website that a user device may access by providing an attempted login that is authenticated by the template system 320. According to some embodiments, web server 410 may include software tools, similar to those described with respect to user device 402 above, that may allow web server 410 to obtain network identification data from user device 402. The web server may also be hosted by an online provider of website hosting, networking, cloud, or backup services, such as Microsoft Azure™ or Amazon Web Services™.

The local network 412 may include any type of computer networking arrangement used to exchange data in a localized area, such as WiFi, Bluetooth™, Ethernet, and other suitable network connections that enable components of the data manipulation system 408 to interact with one another and to connect to the network 406 for interacting with components in the system 400 environment. In some embodiments, the local network 412 may include an interface for communicating with or linking to the network 406. In other embodiments, certain components of the data manipulation system 408 may communicate via the network 406, without a separate local network 406.

The data manipulation system 408 may be hosted in a cloud computing environment (not shown). The cloud computing environment may provide software, data access, data storage, and computation. Furthermore, the cloud computing environment may include resources such as applications (apps), VMs, virtualized storage (VS), or hypervisors (HYP). User device 402 may be able to access data manipulation system 408 using the cloud computing environment. User device 402 may be able to access data manipulation system 408 using specialized software. The cloud computing environment may eliminate the need to install specialized software on user device 402.

In accordance with certain example implementations of the disclosed technology, the data manipulation system 408 may include one or more computer systems configured to compile data from a plurality of sources, such as, but not limited to, the template system 320, web server 410, external database 440, and/or the database 416. The template system 320 may correlate compiled data, analyze the compiled data, arrange the compiled data, generate derived data based on the compiled data, and store the compiled and derived data in a database such as the database 416v or the external database 440. According to some embodiments, the database 416 or the external database 440 may be a database associated with an organization and/or a related entity that stores a variety of information relating to customers, transactions, ATM, and business operations. The database 416 or the external database 440 may also serve as a back-up storage device and may contain data and information that is also stored on, for example, database 360, as discussed with reference to FIG. 3.

Embodiments consistent with the present disclosure may include datasets. Datasets may comprise actual data reflecting real-world conditions, events, and/or measurements. However, in some embodiments, disclosed systems and methods may fully or partially involve synthetic data (e.g., anonymized actual data or fake data). Datasets may involve numeric data, text data, and/or image data. For example, datasets may include transaction data, financial data, demographic data, public data, government data, environmental data, traffic data, network data, transcripts of video data, genomic data, proteomic data, and/or other data. Datasets of the embodiments may be in a variety of data formats including, but not limited to, PARQUET, AVRO, SQLITE, POSTGRESQL, MYSQL, ORACLE, HADOOP, CSV, JSON, PDF, JPG, BMP, and/or other data formats.

Datasets of disclosed embodiments may have a respective data schema (e.g., structure), including a data type, key-value pair, label, metadata, field, relationship, view, index, package, procedure, function, trigger, sequence, synonym, link, directory, queue, or the like. Datasets of the embodiments may contain foreign keys, for example, data elements that appear in multiple datasets and may be used to cross-reference data and determine relationships between datasets. Foreign keys may be unique (e.g., a personal identifier) or shared (e.g., a postal code). Datasets of the embodiments may be “clustered,” for example, a group of datasets may share common features, such as overlapping data, shared statistical properties, or the like. Clustered datasets may share hierarchical relationships (e.g., data lineage).

### EXAMPLE USE CASE

The following example use case describes an example of a typical user flow pattern. This section is intended solely for explanatory purposes and not in limitation.

In one example, a customer John is using his computer as a user device 402. John has a comma-separated value file (i.e., input file) with balance data for the last five years and would like to create a visualization of the balance data. John may open an application on his computer to access the template system 320. The template system 320 may generate a first GUI 500 displaying an input template with different options of data to use as first input data. One of the different options can be the input file or the balance data. The template system 320 can transmit the first GUI 500 to the computer for display. In another example, if the balance data or input file is not presented in the GUI as one of the different options of data to use as first input data. John can select the location of the input file through the first GUI 500 to send the input file location to the template system 320. The selection of the location can be a first indication from John's computer of a first selection of first input data. The template system 320 may then receive, via the first GUI 500, the first indication from the computer indicating the first selection of the balance data. Using the location of the input data, the template system 320 may then retrieve the input file from the location to use the balance data in the input file as first input data.

The template system 320 may then generate a second GUI 500 displaying an option of one or more assumption templates, where each of the one or more assumption templates are configured to perform a data analysis. A balance assumption template of the assumption templates can be a predefined template that assumes the first input data will be balance data divided into different years. The template system 320, using a machine learning model, may recognize that the first input data is balance data and can recommend using the balance assumption template to determine a balance structure of liabilities and assets over the last five years. The second GUI 500 can be modified to include a recommendation of the balance assumption template. The second GUI 500 can be transmitted to John's computer. John may then, via the computer, send a selection of the one or more assumption templates or may send a confirmation to proceed with the balance assumption template. The template system 320 may receive the balance assumption template as the selected assumption template.

The template system 320 may then generate a third GUI 500 displaying an output template. The template system 320 may, using a second machine learning model, recommend using a stacked bar graph to display the data analysis of the balance data. The second machine learning model may recommend using the stacked bar graph based on historical runs of the template system 320 where John has previously selected the stacked bar graph as the visualization. In other examples, the second machine learning model may have been trained using training sets to recommend the stacked bar graph when it receives data similar to the balance data or has a selection like the balance assumption template. The template system 320 may then transmit the third GUI 500 to the computer for display. John can then send a third indication that he would like to select the recommended stacked bar graph for the selected output configuration.

The template system 320 may then calculate data analysis using the balance data and the balance assumption template by creating a variable with the balance data as a data structure. The template system 320 can call a python function with the variable as a parameter. The python function can be configured to generate an average of liabilities and assets for different periods of time (i.e., each year in this example). The python function can return an output variable of a data structure with the average of liabilities and assets for each year in the balance data. The template system 320 can make a call to a Tableau function with the output variable as a parameter to generate a stacked bar graph. The template system 320 can then modify the third GUI 500 to display the stacked bar graph along with a table of the output variable. The template system 320 can then transmit the modified third GUI 500 to the computer.

In some examples, disclosed systems or methods may involve one or more of the following clauses:
Clause 1: A system comprising: one or more processors; memory in communication with the one or more processors and storing an input template, one or more assumption templates, an output template, and instructions that are configured to cause the system to: generate a first graphical user interface displaying the input template; transmit the first graphical user interface to a user device for display; receive, via the first graphical user interface, a first indication from the user device indicating a first selection of first input data; receive or retrieve, using the input template, the first input data; generate a second graphical user interface displaying an option of the one or more assumption templates, each of the one or more assumption templates configured to perform a data analysis; transmit the second graphical user interface to the user device for display; receive, via the second graphical user interface, a second indication from the user device indicating one or more selected assumption templates; generate a third graphical user interface displaying the output template; transmit the third graphical user interface to the user device for display; receive, via the third graphical user interface, a third indication from the user device indicating a selected output configuration; calculate the data analysis using the one or more selected assumption templates and the first input data from the input template; and output the data analysis according to the third indication from the user device using the selected output configuration.
Clause 2: The system of clause 1, wherein the memory stores further instructions as part of the input template that are configured to cause the system to: update the first graphical user interface to display a preview of the first input data; and transmit the updated first graphical user interface to the user device for display.
Clause 3: The system of clause 2, wherein the memory stores further instructions as part of the input template that are configured to cause the system to: receive a fourth indication from the user device to manipulate the first input data; manipulate the first input data according to the fourth indication from the user device; further update the first graphical user interface to display an updated preview of the manipulated first input data; and transmit the updated first graphical user interface to the user device for display.
Clause 4: The system of clause 3, wherein manipulating the first input data comprises removing a second selection of the first input data, changing start dates and end dates, changing data versions, changing database versions, or combinations thereof.
Clause 5: The system of clause 2, wherein the memory stores further instructions as part of the input template that are configured to cause the system to: receive a fifth indication from the user device to add second input data; receive or retrieve, using the input template the second input data according to the fifth indication; further update the first graphical user interface to display a preview of the first input data and the second input data; and transmit the updated first graphical user interface to the user device for display.
Clause 6: The system of clause 5, wherein the memory stores further instructions as part of the input template that are configured to cause the system to: receive a sixth indication from the user device to overlay the first input data and the second input data; further update the first graphical user interface to display an overlay preview of the first input data and the second input data; and transmit the updated first graphical user interface to the user device for display.
Clause 7: The system of clause 1, wherein the memory stores further instructions that are configured to cause the system to: receive, as part of the second indication from the user device, additional instructions to adjust the one or more assumption templates.
Clause 8: The system of clause 7, wherein the additional instructions to adjust the one or more assumption templates further comprise utilizing shorthand commands.
Clause 9: The system of clause 1, wherein the memory further stores a drop-down template, wherein the drop-down template is configured to cause the system to: generate a fourth graphical user interface to manipulate the first input data; transmit the fourth graphical user interface to the user device; and receive, via the fourth graphical user interface, a third selection to manipulate the first input data.
Clause 10: A system comprising: one or more processors; memory in communication with the one or more processors and storing instructions that are configured to cause the system to: generate a first graphical user interface for indicating input data; transmit the first graphical user interface to a user device for display; receive, via the first graphical user interface, a first indication from the user device indicating a first selection of first input data; generate a second graphical user interface displaying an option of one or more assumption templates, each of the one or more assumption templates configured to perform a data analysis; transmit the second graphical user interface to the user device for display; receive, via the second graphical user interface, a second indication from the user device indicating one or more selected assumption templates; process the first input data from the input data using one or more selected assumption templates to generate first output data; generate a third graphical user interface displaying the first output data; and transmit the third graphical user interface to the user device for display.
Clause 11: The system of clause 10, wherein the memory stores further instructions that are configured to cause the system to: update the first graphical user interface to display a preview of the first input data; and transmit the updated first graphical user interface to the user device for display.
Clause 12: The system of clause 11, wherein the memory stores further instructions that are configured to cause the system to: receive a third indication from the user device to manipulate the first input data; manipulate the first input data according to the third indication from the user device; further update the first graphical user interface to display an updated preview of the manipulated first input data; and transmit the updated first graphical user interface to the user device for display.
Clause 13: The system of clause 11, wherein the memory stores further instructions that are configured to cause the system to: receive a fourth indication from the user device to add second input data; receive or retrieve the second input data according to the fourth indication; further update the first graphical user interface to display a preview of the first input data and the second input data; and transmit the updated first graphical user interface to the user device for display.
Clause 14: The system of clause 13, wherein the memory stores further instructions that are configured to cause the system to: receive a fifth indication from the user device to overlay the first input data and the second input data; further update the first graphical user interface to display an overlay preview of the first input data and the second input data; and transmit the updated first graphical user interface to the user device for display.
Clause 15: The system of clause 10, wherein the memory stores further instructions that are configured to cause the system to: receive, as part of the second indication from the user device, additional instructions to adjust the one or more assumption templates.
Clause 16: The system of clause 10, wherein the memory stores further instructions that are configured to cause the system to: generate a fourth graphical user interface with drop down options to manipulate the first input data; transmit the fourth graphical user interface to the user device; and receive, via the fourth graphical user interface, a second selection to manipulate the first input data.
Clause 17: A system comprising: one or more processors; memory in communication with the one or more processors and storing instructions that are configured to cause the system to: generate a first graphical user interface for indicating input data; transmit the first graphical user interface to a user device for display; receive, via the first graphical user interface, a first indication from the user device indicating a selection of first input data; receive or retrieve the first input data according to the selection of first input data of the first indication; update the first graphical user interface to display the first input data; transmit the updated first graphical user interface to the user device for display; generate a second graphical user interface displaying an option of one or more assumption templates, each of the one or more assumption templates configured to perform a data analysis; transmit the second graphical user interface to the user device for display; receive, via the second graphical user interface, a second indication from the user device indicating one or more selected assumption templates and a selected output configuration; and process the first input data from the input data using one or more selected assumption templates to generate first output data in the selected output configuration.
Clause 18: The system of clause 17, wherein the memory stores further instructions that are configured to cause the system to: while receiving a third indication from the user device to manipulate the first input data, iteratively perform the following steps: manipulate the first input data according to the third indication from the user device; update the first graphical user interface to display an updated preview of the manipulated first input data; and transmit the updated first graphical user interface to the user device for display.
Clause 19: The system of clause 17, wherein the memory stores further instructions that are configured to cause the system to: receiving, as part of the second indication from the user device, additional instructions to adjust the one or more assumption templates.
Clause 20: The system of clause 17, wherein the memory stores further instructions that are configured to cause the system to: generate a third graphical user interface to display the first output data; while receiving a fourth indication from the user device to manipulate the first input data, iteratively perform the following steps: manipulate the first output data according to the fourth indication from the user device; update the third graphical user interface to display the manipulated first output data; and transmit the updated third graphical user interface to the user device for display.

The features and other aspects and principles of the disclosed embodiments may be implemented in various environments. Such environments and related applications may be specifically constructed for performing the various processes and operations of the disclosed embodiments or they may include a general-purpose computer or computing platform selectively activated or reconfigured by program code to provide the necessary functionality. Further, the processes disclosed herein may be implemented by a suitable combination of hardware, software, and/or firmware. For example, the disclosed embodiments may implement general purpose machines configured to execute software programs that perform processes consistent with the disclosed embodiments. Alternatively, the disclosed embodiments may implement a specialized apparatus or system configured to execute software programs that perform processes consistent with the disclosed embodiments. Furthermore, although some disclosed embodiments may be implemented by general purpose machines as computer processing instructions, all, or a portion of the functionality of the disclosed embodiments may be implemented instead in dedicated electronics hardware.

The disclosed embodiments also relate to tangible and non-transitory computer readable media that include program instructions or program code that, when executed by one or more processors, perform one or more computer-implemented operations. The program instructions or program code may include specially designed and constructed instructions or code, and/or instructions and code well-known and available to those having ordinary skill in the computer software arts. For example, the disclosed embodiments may execute high level and/or low-level software instructions, such as machine code (e.g., such as that produced by a compiler) and/or high-level code that can be executed by a processor using an interpreter.

The technology disclosed herein typically involves a high-level design effort to construct a computational system that can appropriately process unpredictable data. Mathematical algorithms may be used as building blocks for a framework, however certain implementations of the system may autonomously learn their own operation parameters, achieving better results, higher accuracy, fewer errors, fewer crashes, and greater speed.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

Certain implementations of the disclosed technology described above with reference to user devices may include mobile computing devices. Those skilled in the art recognize that there are several categories of mobile devices, generally known as portable computing devices that can run on batteries but are not usually classified as laptops. For example, mobile devices can include, but are not limited to portable computers, tablet PCs, internet tablets, PDAs, ultra-mobile PCs (UMPCs), wearable devices, and smart phones. Additionally, implementations of the disclosed technology can be utilized with internet of things (IoT) devices, smart televisions and media devices, appliances, automobiles, toys, and voice command devices, along with peripherals that interface with these devices.

In this description, numerous specific details have been set forth. It is to be understood, however, that implementations of the disclosed technology may be practiced without these specific details. In other instances, well-known methods, structures, and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

It is to be understood that the mention of one or more method steps does not preclude the presence of additional method steps or intervening method steps between those steps expressly identified. Similarly, it is also to be understood that the mention of one or more components in a device or system does not preclude the presence of additional components or intervening components between those components expressly identified.

Although embodiments are described herein with respect to systems or methods, it is contemplated that embodiments with identical or substantially similar features may alternatively be implemented as systems, methods and/or non-transitory computer-readable media.

As used herein, unless otherwise specified, the use of the ordinal adjectives “first,” “second,” “third,” etc., to describe a common object, merely indicates that different instances of like objects are being referred to, and is not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system comprising:
one or more processors;
memory in communication with the one or more processors and storing an input template, one or more assumption templates, an output template, and instructions that are configured to cause the system to:
generate a first graphical user interface displaying the input template;
transmit the first graphical user interface to a user device for display;
receive, via the first graphical user interface, a first indication from the user device indicating a first selection of first input data;
receive or retrieve, using the input template, the first input data;
generate a second graphical user interface displaying an option of the one or more assumption templates, each of the one or more assumption templates configured to perform a data analysis;
transmit the second graphical user interface to the user device for display;
receive, via the second graphical user interface, a second indication from the user device indicating one or more selected assumption templates;
generate a third graphical user interface displaying the output template;
transmit the third graphical user interface to the user device for display;
receive, via the third graphical user interface, a third indication from the user device indicating a selected output configuration;
calculate the data analysis using the one or more selected assumption templates and the first input data from the input template; and
output the data analysis according to the third indication from the user device using the selected output configuration.

2. The system of claim 1, wherein the memory stores further instructions as part of the input template that are configured to cause the system to:
update the first graphical user interface to display a preview of the first input data; and
transmit the updated first graphical user interface to the user device for display.

3. The system of claim 2, wherein the memory stores further instructions as part of the input template that are configured to cause the system to:
receive a fourth indication from the user device to manipulate the first input data;
manipulate the first input data according to the fourth indication from the user device;
further update the first graphical user interface to display an updated preview of the manipulated first input data; and
transmit the updated first graphical user interface to the user device for display.

4. The system of claim 3, wherein manipulating the first input data comprises removing a second selection of the first input data, changing start dates and end dates, changing data versions, changing database versions, or combinations thereof.

5. The system of claim 2, wherein the memory stores further instructions as part of the input template that are configured to cause the system to:
receive a fifth indication from the user device to add second input data;
receive or retrieve, using the input template the second input data according to the fifth indication;
further update the first graphical user interface to display a preview of the first input data and the second input data; and
transmit the updated first graphical user interface to the user device for display.

6. The system of claim 5, wherein the memory stores further instructions as part of the input template that are configured to cause the system to:
receive a sixth indication from the user device to overlay the first input data and the second input data;
further update the first graphical user interface to display an overlay preview of the first input data and the second input data; and
transmit the updated first graphical user interface to the user device for display.

7. The system of claim 1, wherein the memory stores further instructions that are configured to cause the system to:
receive, as part of the second indication from the user device, additional instructions to adjust the one or more assumption templates.

8. The system of claim 7, wherein the additional instructions to adjust the one or more assumption templates further comprise utilizing shorthand commands.

9. The system of claim 1, wherein the memory further stores a drop-down template, wherein the drop-down template is configured to cause the system to:
generate a fourth graphical user interface to manipulate the first input data;
transmit the fourth graphical user interface to the user device; and
receive, via the fourth graphical user interface, a third selection to manipulate the first input data.

10. A system comprising:
one or more processors;
memory in communication with the one or more processors and storing instructions that are configured to cause the system to:
generate a first graphical user interface for indicating input data;
transmit the first graphical user interface to a user device for display;
receive, via the first graphical user interface, a first indication from the user device indicating a first selection of first input data;
generate a second graphical user interface displaying an option of one or more assumption templates, each of the one or more assumption templates configured to perform a data analysis;
transmit the second graphical user interface to the user device for display;
receive, via the second graphical user interface, a second indication from the user device indicating one or more selected assumption templates;
process the first input data from the input data using one or more selected assumption templates to generate first output data;
generate a third graphical user interface displaying the first output data; and
transmit the third graphical user interface to the user device for display.

11. The system of claim 10, wherein the memory stores further instructions that are configured to cause the system to:
update the first graphical user interface to display a preview of the first input data; and
transmit the updated first graphical user interface to the user device for display.

12. The system of claim 11, wherein the memory stores further instructions that are configured to cause the system to:
receive a third indication from the user device to manipulate the first input data;
manipulate the first input data according to the third indication from the user device;
further update the first graphical user interface to display an updated preview of the manipulated first input data; and
transmit the updated first graphical user interface to the user device for display.

13. The system of claim 11, wherein the memory stores further instructions that are configured to cause the system to:
receive a fourth indication from the user device to add second input data;
receive or retrieve the second input data according to the fourth indication;
further update the first graphical user interface to display a preview of the first input data and the second input data; and
transmit the updated first graphical user interface to the user device for display.

14. The system of claim 13, wherein the memory stores further instructions that are configured to cause the system to:
receive a fifth indication from the user device to overlay the first input data and the second input data;
further update the first graphical user interface to display an overlay preview of the first input data and the second input data; and
transmit the updated first graphical user interface to the user device for display.

15. The system of claim 10, wherein the memory stores further instructions that are configured to cause the system to:
receive, as part of the second indication from the user device, additional instructions to adjust the one or more assumption templates.

16. The system of claim 10, wherein the memory stores further instructions that are configured to cause the system to:
generate a fourth graphical user interface with drop down options to manipulate the first input data;
transmit the fourth graphical user interface to the user device; and
receive, via the fourth graphical user interface, a second selection to manipulate the first input data.

17. A system comprising:
one or more processors;
memory in communication with the one or more processors and storing instructions that are configured to cause the system to:
generate a first graphical user interface for indicating input data;
transmit the first graphical user interface to a user device for display;
receive, via the first graphical user interface, a first indication from the user device indicating a selection of first input data;
receive or retrieve the first input data according to the selection of first input data of the first indication;
update the first graphical user interface to display the first input data;
transmit the updated first graphical user interface to the user device for display;
generate a second graphical user interface displaying an option of one or more assumption templates, each of the one or more assumption templates configured to perform a data analysis;
transmit the second graphical user interface to the user device for display;
receive, via the second graphical user interface, a second indication from the user device indicating one or more selected assumption templates and a selected output configuration; and
process the first input data from the input data using one or more selected assumption templates to generate first output data in the selected output configuration.

18. The system of claim 17, wherein the memory stores further instructions that are configured to cause the system to:
while receiving a third indication from the user device to manipulate the first input data, iteratively perform the following steps:
manipulate the first input data according to the third indication from the user device;
update the first graphical user interface to display an updated preview of the manipulated first input data; and
transmit the updated first graphical user interface to the user device for display.

19. The system of claim 17, wherein the memory stores further instructions that are configured to cause the system to:
receiving, as part of the second indication from the user device, additional instructions to adjust the one or more assumption templates.

20. The system of claim 17, wherein the memory stores further instructions that are configured to cause the system to:
generate a third graphical user interface to display the first output data;
while receiving a fourth indication from the user device to manipulate the first input data, iteratively perform the following steps:
manipulate the first output data according to the fourth indication from the user device;
update the third graphical user interface to display the manipulated first output data; and
transmit the updated third graphical user interface to the user device for display.
